(19) United States
(12) Patent Application Publication
(10) Pub. No.: US 2004/0189449 A1
(43) Pub. Date: Sep. 30, 2004

(54) Remote control vehicle security system

(76) Inventor: Jose M. Lopez, Staten Island, NY (US)

Correspondence Address: Sean A. Kaufhold, P.O. Box 131447, Carlsbad, CA, 92013, US

(21) Appl. No.: 10/397,443

(22) Filed: Mar. 27, 2003

(51) Int. Cl. B60R 25/10

(52) U.S. Cl. 340/426.22

(57) ABSTRACT

A remote control vehicle security system includes a light emitter that is mounted on a vehicle. A processor for selectively turning the light on or off is electrically coupled to the light emitter. A power supply is electrically coupled to the processor. A cellular receiver for receiving cellular transmissions is operationally coupled to the processor. The processor turns on the light when the processor receives a signal from the cellular receiver.

### BACKGROUND OF THE INVENTION

1. Field of the Invention

The present invention relates to vehicle security systems and more particularly pertains to a new vehicle security system for emitting a visual signal on a stolen vehicle.

2. Description of the Prior Art

The use of vehicle security systems is known in the prior art. However, the majority of such systems are used for emitting an audible alarm or for deactivating the ignition system of a vehicle. While these devices fulfill their respective, particular objectives and requirements, the need remains for a device that gives a visual cue that an observed vehicle is stolen.

### SUMMARY OF THE INVENTION

The present invention meets the needs presented above by including a light emitter which emits a bright light when a vehicle is being driven by an unauthorized driver.

Another object of the present invention is to provide a new vehicle security system that is turned on by a cellular phone or by a transmitter. By using actuating devices which are not dependent upon the electrical system of the vehicle, the system will not be able to be bypassed by a person attempting to steal the vehicle.

To this end, the present invention generally comprises a light emitter that is mounted on a vehicle. A processor for selectively turning the light on or off is electrically coupled to the light emitter. A power supply is electrically coupled to the processor. A cellular receiver for receiving cellular transmissions is operationally coupled to the processor. The processor turns on the light when the processor receives a signal from the cellular receiver.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic in-use view of a remote control vehicle security system according to the present invention.

FIG. 2 is a schematic perspective view of the present invention.

FIG. 3 is an electric schematic view of the present invention.

### DESCRIPTION OF THE PREFERRED EMBODIMENT

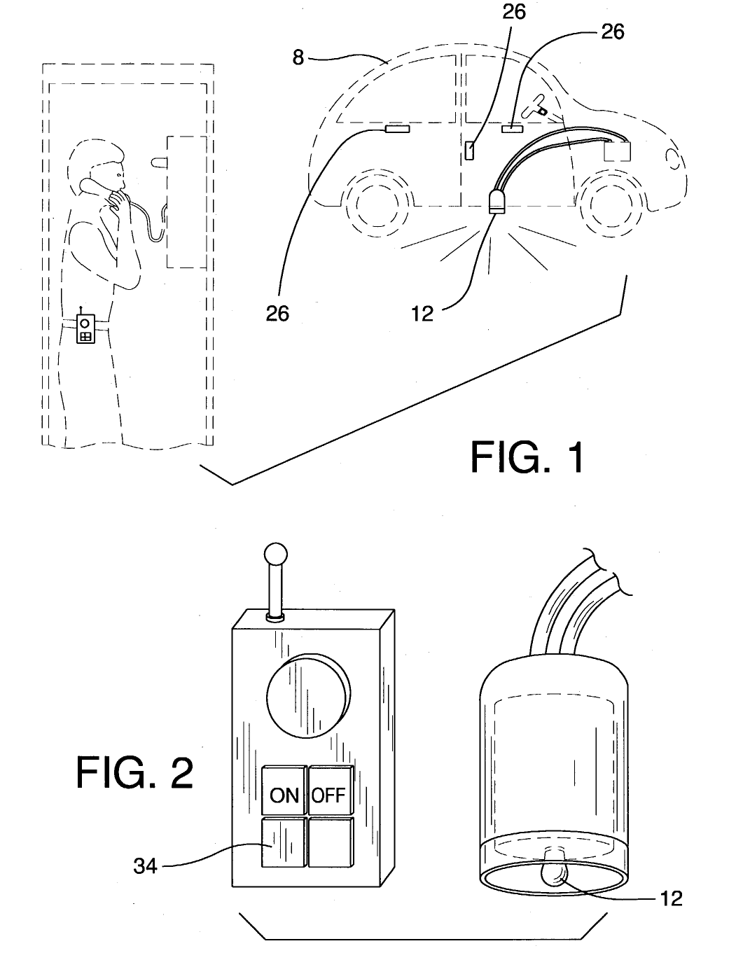

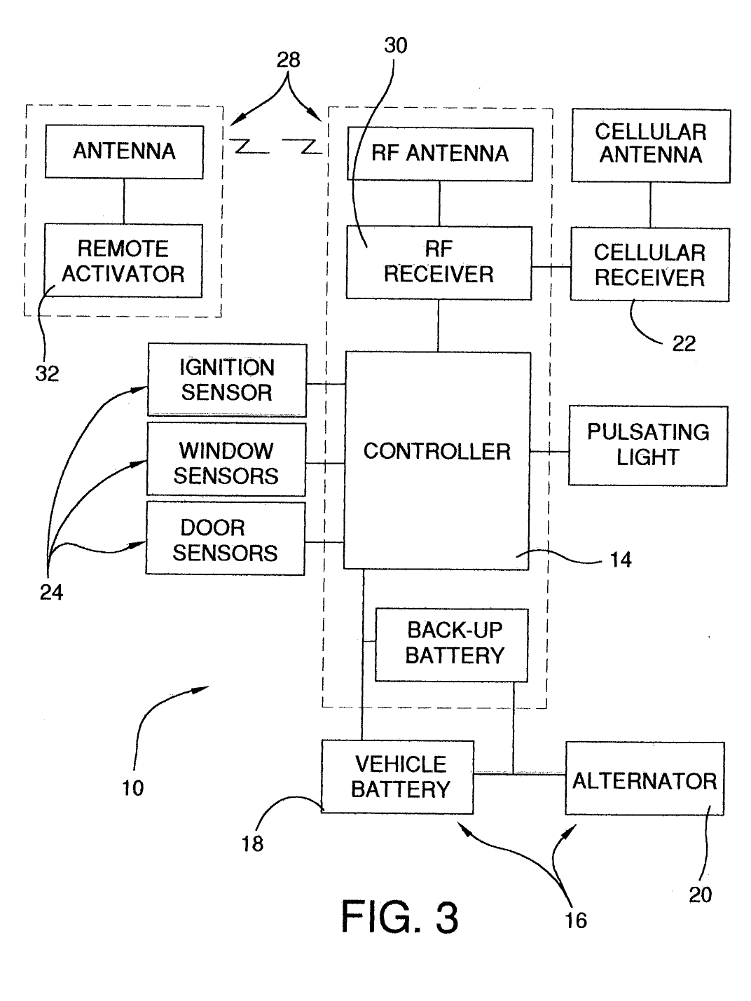

With reference now to the drawings, and in particular to FIGS. 1 through 3 thereof, a new vehicle security system embodying the principles and concepts of the present invention and generally designated by the reference numeral 10 will be described.

As best illustrated in FIGS. 1 through 3, the remote control vehicle security system 10 generally comprises a light emitter 12 that is mounted on a vehicle 8. The light emitter 12 is preferably disposed on a bottom side of the vehicle 8 and ideally comprises a high-output light source such as a halogen lamp. The light emitter 12 may be a colored light, such as blue or red to make its appearance more noticeable.

A processor 14, or control, is electrically coupled to the light emitter 12, and selectively turns the light emitter 12 on or off. It is preferred that the processor 14 is adapted for pulsating the light emitter when the light emitter 12 is turned on. The pulsating nature of the light emitter 12 will better ensure that the light emitter 12 is noticed.

A power supply 16 is electrically coupled to the processor 14. The power supply 16 preferably includes a battery 18 used by the vehicle and a back-up battery 20. The back-up battery 20 reduces the reliance on the vehicle's main power supply in such cases when the vehicle's battery 18 is tampered with.

A cellular receiver 22 for receiving cellular transmissions is operationally coupled to the processor 14. It is intended that the cellular receiver 22 be adapted for receiving transmissions as would a conventional cellular phone and would be adaptable as existing technologies adapt to new wireless technologies for cellular phones.

A vehicle entry detection assembly 24 is integrated into the vehicle 8 as would a conventional vehicle security system. The detection assembly 24 comprises a plurality of sensors 26 for sending a signal to the processor when the vehicle entry detection assembly detects a door opening of the vehicle, a window opening of the vehicle or an engagement of an ignition of the vehicle 8. The vehicle entry detection assembly is electrically coupled to the processor. The detection assembly includes a plurality of door, window and ignition sensors 26. The sensors 26 are preferably hard wired to the processor, though wireless signals may also be employed to couple the sensors to the processor.

An activation system 28 selectively activates or deactivates the detection assembly 24. The activation system 28 includes a radio receiver 30 for receiving radio transmissions. The radio receiver 30 is electrically coupled to the processor 14. A transmitter 32 transmits a radio signal to the radio receiver 30 for selectively activating or deactivating the vehicle entry detection assembly 24. At least one actuator 34 is operationally coupled to the transmitter 32 for actuating the transmitter 32.

The system 12 is used in two possible manners. First, as a conventional security system, the transmitter 32 activates the detection assembly 24. When a door or window are opened, or the ignition engaged to start the vehicle 8, the detection assembly 24 sends a signal to the processor 14 so that the processor 14 turns on the light emitter 12 to indicate that the vehicle 8 is being operated by an unauthorized person. Second, as an auxiliary security system, should the owner of the vehicle 8 realize that the vehicle has been stolen but that the detection assembly 24 was not activated, the owner may telephone the cellular receiver 22 which will cause the processor 14 to turn on the light emitter 12. In either case, the light emitter 12 emits a bright illumination to attract law enforcement.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle security system comprising:
a light emitter being mounted on a vehicle;
a processor for selectively turning said light emitter on or off being operationally coupled to said light emitter;
a power supply being electrically coupled to said processor;
a cellular receiver for receiving cellular transmissions being operationally coupled to said processor; and
wherein said processor turns on said light emitter when said processor receives a signal from said cellular receiver.

2. The vehicle security system of claim 1, where the light emitter is disposed on a bottom side of the vehicle.

3. The vehicle security system of claim 1, wherein said processor is adapted for pulsating said light emitter when said light emitter is turned on.

4. The vehicle security system of claim 1, further including a vehicle entry detection assembly comprising a plurality of sensors for sending a signal to said processor when said vehicle entry detection assembly detects a door opening of the vehicle, a window opening of the vehicle or an engagement of an ignition of the vehicle, said vehicle entry detection assembly being electrically coupled to said processor, said activating system being operationally coupled to said vehicle entry detection assembly, wherein said processor is turned on said light emitter when said vehicle entry detection assembly transmits a signal to said processor.

5. The vehicle security system of claim 4, wherein said activating system includes a radio receiver for receiving radio transmissions, said radio receiver being electrically coupled to said processor, a transmitter for transmitting a radio signal to said radio receiver for selectively activating or deactivating said vehicle entry detection assembly, at least one actuator being operationally coupled to said transmitter for actuating said transmitter.

6. A vehicle security system comprising:
a light emitter being mounted on a vehicle, the light emitter being disposed on a bottom side of the vehicle;
a processor for selectively turning said light on or off being operationally coupled to said light emitter, wherein said processor is adapted for pulsating said light emitter when said light emitter is turned on;
a power supply being electrically coupled to said processor, said power supply including a vehicle battery and a back-up battery;
a cellular receiver for receiving cellular transmissions being operationally coupled to said processor;
a vehicle entry detection assembly comprising a plurality of sensors for sending a signal to said processor when said vehicle entry detection assembly detects a door opening of the vehicle, a window opening of the vehicle or an engagement of an ignition of the vehicle, said vehicle entry detection assembly being electrically coupled to said processor;
a radio receiver for receiving radio transmissions, said radio receiver being electrically coupled to said processor;
a transmitter for transmitting a radio signal to said radio receiver for selectively activating or deactivating said vehicle entry detection assembly, at least one actuator being operationally coupled to said transmitter for actuating said transmitter; and
wherein said processor turns on said light emitter when said vehicle entry detection assembly transmits a signal to said processor or said processor receives a signal from said cellular receiver.
